(19) United States
(12) Patent Application Publication
(10) Pub. No.: US 2003/0055663 A1
(43) Pub. Date: Mar. 20, 2003

(54) Method and system for shifting a cost associated with operating a device

(76) Inventor: Christian Struble, Boise, ID (US)

Correspondence Address: HEWLETT-PACKARD COMPANY, Intellectual Property Administration, P.O.Box 272400, Fort Collins, CO, 80527-2400, US

(21) Appl. No.: 09/956,433

(22) Filed: Sep. 20, 2001

(51) Int. Cl. G06F 17/60

(52) U.S. Cl. 705/1

(57) ABSTRACT

In one respect, the invention pertains to a method for shifting a cost associated with operating a device. The method includes executing an agreement to shift the cost associated with operating the device and measuring a consumable resource utilized by the device. The method further includes determining a cost associated with the utilized consumable resource and shifting the cost from a user of the device to a provider of the device. In another respect, the invention utilizes a system for performing the above mentioned method.

### FIELD OF THE INVENTION

This invention relates generally to cost shifting, and more particularly, although not exclusively, to Internet-enabled appliance resource metering and cost shifting.

### BACKGROUND OF THE INVENTION

It is generally known that devices such as appliances provide services to users in homes (e.g., stove, refrigerator, television, personal computer “PC”, heater, air conditioner, etc.) as well as in businesses (e.g., PC, server, printer, heater, air conditioner, etc.). Typically, appliances require resources to operate (e.g., water, gas, electricity, etc.).

Typically, the direct costs associated with the purchase of resources is significant. Additionally, the indirect cost associated with the production, distribution and consumption of resources may also be significant. While the direct costs of resources are typically paid for by the owner or the leasing interest of the appliance, in general, the indirect costs are paid for by society.

In an effort to entice consumers (e.g., individuals, groups, business interests, etc.) to purchase more efficient appliances, various programs have been developed to inform consumers regarding the efficiency of various appliances. Additionally, incentives (e.g., rebates, discounts, etc.) are occasionally provided to consumers to help make the cost of the more efficient and often more expensive appliances attractive.

While these efforts have been somewhat effective in certain instances, they have been much less so in others. For example, a consumer comparing one home heating furnace to another may be persuaded to purchase one furnace that is 20% more efficient than the other. However, the same customer may be much less persuaded to purchase one furnace over the other if the difference in efficiency is only 2%. Additionally, if the resource costs of the appliance are relatively small or poorly understood by the consumer, even a significant increase in efficiency may not persuade a customer to buy the appliance. For example, a 27″ television (“TV”) may use less than 400 watts of electricity and thus, even a 50% increase in efficiency may have little or no impact on consumer buying trends. In a second example, a typical selling point for a gas range is how much heat each burner produces, while no mention of efficiency may be proffered.

### SUMMARY OF THE INVENTION

In one respect, the invention pertains to a method for shifting a cost associated with operating a device. The method includes executing an agreement to shift the cost associated with operating the device and measuring a consumable resource utilized by the device. The method further includes determining a cost associated with the utilized consumable resource and shifting the cost from a user of the device to a provider of the device.

In another respect, the invention utilizes a system for shifting a cost associated with operating a device. The device is operable to consume a resource. The system includes an executed agreement configured to shift the cost associated with operating the device and a meter configured to measure an amount of the resource consumed. The resource has an associated cost per amount consumed. The system further includes a processor system configured to calculate the cost associated with operating the device based on the amount of the resource consumed and the associated cost per amount consumed. The processor system is further configured to shift the cost associated with operating the device from a user of the device to a provider of the device.

In comparison to known prior art, certain embodiments of the invention are capable of achieving certain aspects, including some or all of the following: (1) environmentally responsible practices may be enabled; (2) provide the manufacturer both the information and an incentive to make devices that are more energy or resource efficient; and (3) enable proactive repair of a product based on the resource efficiency of the product over time. Those skilled in the art will appreciate these and other aspects of various embodiments of the invention upon reading the following detailed description of a preferred embodiment with reference to the below-listed drawings.

### BRIEF DESCRIPTION OF THE DRAWINGS

FIG. 1 is a diagram of an exemplary environment according to an embodiment of the invention; and

FIG. 2 is a flow chart of an exemplary method, according to an embodiment of the invention.

### DETAILED DESCRIPTION OF A PREFERRED EMBODIMENT

For simplicity and illustrative purposes, the principles of the invention are described by referring mainly to an exemplary embodiment thereof, particularly with references to a system to shift cost. However, one of ordinary skill in the art would readily recognize that the same principles are equally applicable to, and can be implemented in, a system capable of shifting resources and services, and that any such variations are within the scope of the invention.

While in the following description numerous specific details are set forth in order to provide a thorough understanding of an embodiment of the invention, in other instances, well known methods and structures have not been described in detail so as not to obscure the invention. Additionally, the invention may be embodied in various forms, several of which are described below.

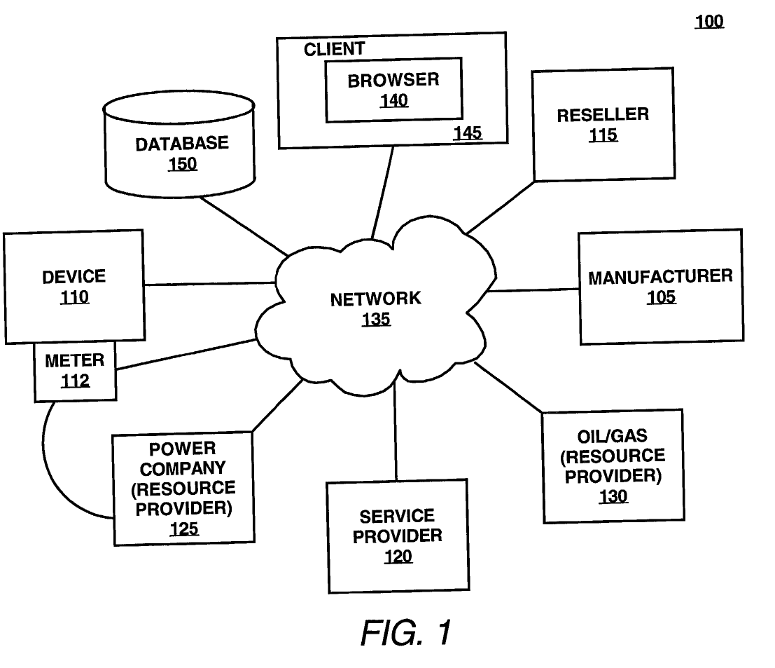

FIG. 1 is a diagram of an exemplary environment 100 according to an embodiment of the invention. The environment 100 includes a manufacturer 105, a device 110, a meter 112, a reseller 115, and a service provider 120. The environment 100 further includes at least one resource provider such as a power company 125 and gas company 130. Additionally, the environment 100 includes a network 135 such as the Internet, a browser 140 operating on a client computer 145, and a database 150.

The manufacturer 105 may produce the device 110 for sale or lease to the public or business interest. In one form, the device 110 may include the meter 112. In another form, the meter 112 may be a separate device operable for connection to the device 110. The meter 112 may be operable to measure a resource flowing into or out of the device 110. Furthermore, the meter 112 may be connected to the various elements of environment 100 and thus, the elements may access data acquired by the meter 112.

The business interest may include the reseller 115. The reseller 115 may be directly or indirectly associated with the manufacturer 105 and may further sell or lease the device 110. In addition, the service provider 120 may maintain and/or repair the device 110. For example, if the device 110 is a printer, the service provider 120 may clean, lubricate, proactively replace parts that may fail, and supply consumable resources (e.g., paper, toner, etc.) as well as repair the printer.

The power company 125 and/or the gas company 130 may supply consumable resources (e.g., electricity and gas respectively) to the device 110. Although not depicted in the FIG. 1, the consumable resources may be supplied via power lines, pipes, tanks, etc. While paper, toner, electricity and gas are mentioned as consumable resources, the invention is not limited to the consumable resources mentioned, but rather, the invention may include any form of energy, material or substance supplied to the device 110 or stored within the device 110.

In an exemplary embodiment of the invention, the network 135 may facilitate two way communication among the various elements of the environment 100. For example, a user of the browser 140 may communicate with the device 110 via the network 135. The device 110 may be configured to output data and this data may be received by the meter 112 and other elements of the environment 100 and/or may be stored to the database 150. Additionally, data from the device 110 may be utilized in conjunction with data from other elements of the environment 100 to generate data. This generated data may be output, received and stored in a manner similar to data originating from the device 110. For example, the device 110 may provide data corresponding to the amount of electricity used during a predefined period (e.g., a month). The power company 125 may provide a unit cost of electricity during the predefined period. The service provider 120 may access the amount and the unit cost of electricity to determine an operational cost of the device during the predefined period.

For the purpose of this disclosure, the term “user” is defined as a person, persons, and/or business interest that owns, leases and/or operates a device. Additionally, the term “provider” is defined for the purpose of this disclosure as a person, persons and/or business interest that manufactures, sells and/or leases the device and/or provides a service associated with the device. Furthermore, the terms “connected” and its variants, as used herein, mean connected directly or indirectly through an intermediary element.

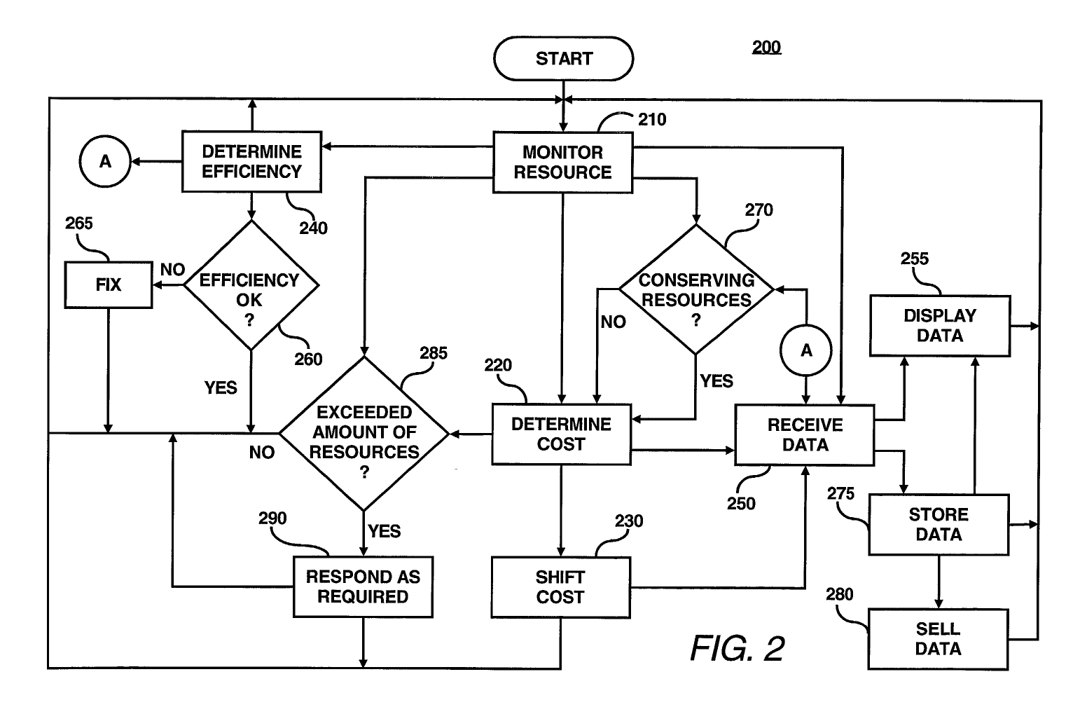

FIG. 2 is an exemplary flow chart of a method 200, according to an embodiment of the invention. The method 200 includes a step 210 of monitoring a resource, a step 220 of determining a cost, and a step 230 of shifting the cost. In a preferred embodiment, prior to initiation of the method 200, a contractual agreement between a user and a provider may be executed. The agreement may stipulate a party responsible for costs associated with the use of a device (e.g., consumable resource costs). For example, the user may lease the device (e.g., a washing machine) from the provider. As part of the lease agreement, the provider may accept responsibility for paying all or part of the electricity, water, and sewage costs associated with operating the washing machine.

In response to measuring an amount of at least one consumable resource, the method 200 is initiated In a preferred form, the device is configured in a manner similar to the device 110 described in FIG. 1. For example, if the device is a washing machine, the washing machine would preferably be configured with meters capable of measuring the various resource amounts and relaying these measurements to the provider.

In step 210, a consumable resource is measured. In addition to measuring the consumable resource, it is within the scope of the invention that other values may be measured. For example a waste product or effluent may be directly or indirectly measured. In as much as a volume of waste is correlated to the consumable resource, the volume of waste may be inferred based on the measured consumable resource. Additionally, if a cost is incurred based on the volume of waste generated, it may be said that money is consumed based on the volume of waste. Moreover, if a waste allotment exists, it may be said that the waste allotment is consumed based on the volume of waste.

In step 220, a cost associated with the measured value is determined. In one form, a cost per unit value may be fixed. For example, the cost per unit (unit cost) of water may be set to $0.03 a gallon. This unit cost may be set by a business or utility selling the water or the unit cost may be stipulated in the agreement. In another form, the unit cost may fluctuate. The fluctuation may or may not be periodic. For example, during times of “peak” usage, the unit cost of electricity may be higher than “off hours” and these times may be defined by the utility to occur at regular intervals. In a second example, market driven (e.g., supply and demand, etc.) price fluctuations may cause fuel costs to rise and fall in an apparently random manner.

In step 230, the determined cost may be shifted. In one form, the user of the device may initially pay the determined cost and subsequently some or all of the determined cost may be reimbursed by the provider. In another form, the provider responsible for paying the determined cost may do so directly.

In another exemplary embodiment, the method 200 may provide the capability to monitor a resource efficiency of a device. The method 200 of this exemplary embodiment is similar to the method 200 described above and thus only those features which are reasonably necessary for a complete understanding of this exemplary embodiment are described below.

For example, prior to or during the method 200, the agreement or a warranty contract that includes efficiency may be executed. Currently, warranty contracts are typically “all or nothing” (e.g., either the device works or it does not). However, the method 200 may enable a warranty to guarantee that the device may maintain a predetermined energy efficiency for the duration of the warranty. Thus, once resource metering technology is in place, a service model, a guarantee or warranty of a certain efficiency throughout the product life may be enabled. In this regard, for example, the device may include a meter configured to accumulate a run time for the device over a period of time. The accumulated run time and an accumulated consumed resources for the period of time may be accessed in step 240 to determine the efficiency of the device for the period of time.

In yet another exemplary embodiment, the method 200 may provide access to the data associated with the measured resource. The method 200 of this exemplary embodiment is similar to the method 200 described above and thus only those features which are reasonably necessary for a complete understanding of this embodiment are described below.

In step 250, data associated with the measured resource may be received from some or all of the steps 210, 220, 230 and 240. The received data may be processed for display and forwarded to step 255. Following the step 250, the method 200 may display or provide access to data associated with the measured resource in step 255. For example, in step 255 a display panel on the device 110 may receive the processed data and display a number of values corresponding to the data. Alternatively or in addition to the display panel, in step 255, the user may access data associated with the measured resource via the browser 140 as illustrated in FIG. 1. In this regard, the device and/or another element of the environment 100 may be configured for secure remote access. The user, having the ability to see data associated with the measured resource (e.g., usage patterns, costs, efficiencies, etc.) may be compelled to put some constraints on their (i.e., the user's) resource usage.

In another form, a user of a service plan associated with the device may utilize the method 200 to access data associated with the service plan. For example if the device is a mobile phone, the user may purchase a number of minutes of call time. In this regard, the service plan may include an amount of service use. This amount of service use is purchased at one rate and any additional service use may incur an additional fee typically at a relatively higher rate. In a conventional plan, it may be difficult, time consuming and/or expensive to determine an amount of service used or service remaining. For example, the user of a conventional mobile phone service plan may be required to call a phone number (using phone service minutes) to inquire how many minutes of phone service the user has remaining. In this form, the method 200 may provide the user the capability to access data associated with the service plan via the browser 140 for example. In a second example, if the device includes an embedded virtual machine, the device may be configured to periodically send a message to the device and/or an email account in step 250. The message may be displayed in step 255 and may include time used, number dialed, time remaining, etc.

In a further exemplary embodiment, the method 200 may provide the user or the provider the capability to proactively repair the device based on a determined resource efficiency of the device. The method 200 of this embodiment is similar to the method 200 described above and thus only those features which are reasonably necessary for a complete understanding of this embodiment are described below.

For example, prior to or during the method 200, the agreement or a warranty contract that includes a contingency for proactive repair may be executed. In step 240, the efficiency of the device may be determined as described above. In one form, the efficiency of the device may be known. A change in efficiency may initiate a response as required by the agreement. For example, if in step 260, it is determined that a significant change in efficiency has occurred, measures to proactively repair the device (e.g., change a filter, lubricate moving parts, clean or replace parts, etc.) may be initiated in step 265. In another form, the efficiency of the device may not be known initially. Over time, data related to the efficiency of the device may be accumulated. The accumulated data may be referenced as more recent efficiency data is acquired. If in step 260, it is determined that a significant change in efficiency has occurred, measures to proactively repair the device may be initiated in step 265.

In a yet further exemplary embodiment, the method 200 may provide a vehicle from which a utility may provide an incentive to the user of the device to conserve energy. The method 200 of this embodiment is similar to the method 200 described above and thus only those features which are reasonably necessary for a complete understanding of this embodiment are described below.

Prior to or during the method 200, a contractual agreement between the provider and the user may be executed. In way of providing a motivation for this embodiment, currently, some utilities are trying to get users to conserve energy. These utilities have set up variable rates for users that use less electricity. Users that conserve resources are charged a lower per kilowatt rate than other users. The method 200 may enable a user of a particular device to receive incentives to conserve resources, particularly for devices where customers control the resources used. For example, in step 270, the utility may determine if the user is conserving energy based on the measured resource and/or the determined efficiency. If it is determined the user is conserving resources, the utility may charge the user a relatively low rate for the resource (resource rate). However, if it is determined the user is not conserving resources, the utility may charge the user a relatively high resource rate. In one form of the method 200, the resource rate resulting from the step 270 may be utilized by the step 220 to determine the cost of the resource consumed.

In an additional exemplary embodiment, the method 200 may provide the capability to collect data associated with resource usage by one or more users. The method 200 of this embodiment is similar to the method 200 described above and thus only those features which are reasonably necessary for a complete understanding of this embodiment are described below.

In a preferred form, the user may be provided the opportunity to participate in a program to collect statistics on users in return for some form of reward. For example, the user may be paid to have statistics gathered on their resource usage. The statistics gathered may be valuable as a marketing research tool. In this regard, in step 250, the received data associated with the measured resource may be forwarded to the database 150 (e.g., memory, disk drive, etc.). In step 275, the data may be received by the database 150 and stored. In step 280, the data may be sold to a business interest. Alternatively, the data need not be stored in step 275 and may be sent directly to the business interest.

In a yet additional exemplary embodiment, the method 200 may provide the user the control of the flow of the measured resource. The method 200 of this embodiment is similar to the method 200 described above and thus only those features which are reasonably necessary for a complete understanding of this embodiment are described below.

Prior to or during the method 200, the user may select a quantity or value of a resource. For example, the user may access a control panel on the device 110 or via the browser 140 to input an amount of the resource. If, in step 285, it is determined the selected amount of the resource has been used, the flow of the resource may be stopped in step 290. In this regard, a valve or switch may be utilized to control the flow of the resource. The valve or switch in the device or controlling the flow of the resource to the device may be configured to turn on or shut off the flow as required. In another form, in step 290, in addition to or as an alternative to controlling the flow of a resource, an alarm may be activated or a message (e.g., an email, etc.) may be sent in response to determining in step 285 that the selected amount of the resource has been used.

The method 200 may exist in a variety of forms both active and inactive. For example, they may exist as software program(s) comprised of program instructions in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the program(s) on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. For example, the steps illustrated in FIG. 2 may be performed in an order different from the order shown and/or may be performed simultaneously. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for shifting a cost associated with operating a device, the method comprising:
executing an agreement to shift the cost associated with operating the device;
measuring a consumable resource, wherein the consumable resource is utilized by the device;
determining a cost, wherein the cost is associated with the utilized consumable resource; and
shifting the cost from a user of the device to a provider of the device.

2. The method according to claim 1 further comprising the step of:
providing access to the data associated with the measured resource.

3. The method according to claim 1 further comprising the step of:
determining a resource efficiency based on data associated with the measured resource.

4. The method according to claim 3 further comprising the step of:
rewarding the user based on at least one of the measured resource and the determined resource efficiency, wherein the reward provides an incentive to the user of the device for conserving resources.

5. The method according to claim 3 further comprising the step of:
proactively repairing the device based on the determined resource efficiency of the device.

6. The method according to claim 3 further comprising the steps of:
periodically storing data associated with the resource efficiency; and
monitoring the resource efficiency of the device over time.

7. The method according to claim 6 further comprising the steps of:
monitoring the resource efficiency of the device over a predetermined time period;
determining an average resource efficiency based on the monitored resource efficiency; and
proactively repairing the device based on the average resource efficiency of the device.

8. The method according to claim 1 further comprising the steps of:
executing an agreement to sell data associated with the measured resource; and
selling the data associated with the measured resource.

9. The method according to claim 8 further comprising the step of:
storing the data associated with the measured resource.

10. The method according to claim 1 further comprising the step of:
controlling a flow of the resource based on the measured resource.

11. The method according to claim 10 further comprising the steps of:
selecting an amount of the resource to be used within a predetermined time period; and
controlling the flow of the resource in response to the measured resource exceeding the selected amount of the resource.

12. A system for shifting a cost associated with operating a device, the device being operable to consume a resource, the system comprising:
an executed agreement configured to shift the cost associated with operating the device;
a meter configured to measure an amount of the resource consumed, the resource having an associated cost per amount consumed; and
a processor system configured to:
calculate the cost associated with operating the device based on the amount of the resource consumed and the associated cost per amount consumed; and
shift the cost associated with operating the device from a user of the device to a provider of the device.

13. The system according to claim 12 wherein the processor system is further configured to provide access to the data associated with the measured resource.

14. The system according to claim 12 wherein the processor system is further configured to determine a resource efficiency based on data associated with the measured resource.

15. The system according to claim 14 wherein the processor system is further configured to reward the user based on at least one of the measured resource and the determined resource efficiency.

16. The system according to claim 12 wherein the processor system is further configured to:
periodically store data associated with the resource efficiency; and
monitor the resource efficiency of the device over a predetermined amount of time.

17. The system according to claim 14 wherein the processor system is further configured to:
determine a range of efficiency based on the resource efficiency of the device over a predetermined time period; and
initiate repair of the device in response to the resource efficiency falling outside the determined range of efficiency.

18. The system according to claim 12 further comprising:
an executed agreement to sell data associated with the measured resource; and
a storage system configured to store the data associated with the measured resource.

19. The system according to claim 12 further comprising:
at least one of a valve and a switch operable to control a flow of the resource, wherein the processor system is further configured to control the flow of the resource based on the measured resource.

20. The system according to claim 19 wherein the processor system is further configured to:
receive a selected amount of the resource; and
determine whether the selected amount of the resource has been measured.
